(19) United States
(12) Patent Application Publication
(10) Pub. No.: US 2025/0361701 A1
(43) Pub. Date: Nov. 27, 2025

(54) WATER GENERATION FOR LIFE SUPPORT SYSTEMS

(71) Applicant: Hamilton Sundstrand Space Systems International, Inc., Windsor Locks, CT (US)

(72) Inventor: Yehia F. Khalil, Glastonbury, CT (US)

(21) Appl. No.: 18/673,509

(22) Filed: May 24, 2024

(51) Int. Cl. E03B 3/00; B01D 53/86

(52) U.S. Cl. CPC E03B 3/00; B01D 53/8687; B01D 2256/16

(57) ABSTRACT

Water generation systems include a first stage defining a processing chamber, a heating element operably coupled to the first stage and configured to cause a temperature of the processing chamber to reach at least 350° C. to perform a gasification operation on solid waste deposited within the processing chamber to release gaseous hydrogen, and a second stage defining a reaction chamber that includes a reacting catalyst arranged within the reaction chamber, the reacting catalyst configured to catalyze gaseous hydrogen released from the solid waste and carbon dioxide to generate water and methane.

### BACKGROUND

The subject matter disclosed herein generally relates to water generation and, more particularly, to water generation systems for life support and space travel.

Human exploration into space poses many challenges, particularly with respect to resources for ensuring human survivability and safety. For example, generation of drinkable or otherwise usable water is a key focus to ensure human safety and longevity when in space, deep-space, low-gravity environments, and/or on celestial bodies (e.g., the Moon, Mars, asteroids, etc.). Further, water generation may be important for generation of fuel or for other purposes, and thus these systems may be mission critical. For example, generated water can be used for fuel generation, such as through electrolysis and generating gaseous oxygen (O₂) and gaseous hydrogen (H₂). Accordingly, improved systems for water generation can provide many advantages for crew safety and longevity along with generation of water for other uses.

### SUMMARY

According to some embodiments, water generation systems are provided. The water generation systems may be used for life support and/or water generation, such as for space exploration. The water generation systems include a first stage defining a processing chamber, a heating element operably coupled to the first stage and configured to cause a temperature of the processing chamber to reach at least 350° C. to perform a gasification operation on solid waste deposited within the processing chamber to release gaseous hydrogen, and a second stage defining a reaction chamber that includes a reacting catalyst arranged within the reaction chamber, the reacting catalyst configured to catalyze gaseous hydrogen released from the solid waste and carbon dioxide to generate water and methane.

In addition to one or more of the features described herein, or as an alternative, further embodiments of the water generation systems may include that the processing chamber is defined between a first perforated plate and a second perforated plate, wherein the second perforated plate is arranged between the processing chamber and the reaction chamber in a flow direction of the gaseous hydrogen.

In addition to one or more of the features described herein, or as an alternative, further embodiments of the water generation systems may include that the second perforated plate comprises at least one of filters and holes sizes selected to permit gaseous hydrogen to pass therethrough and prevent particulate matter from passing therethrough.

In addition to one or more of the features described herein, or as an alternative, further embodiments of the water generation systems may include that the first perforated plate comprises holes or opening sized to permit a carbonaceous byproduct to pass therethrough and exit the processing chamber.

In addition to one or more of the features described herein, or as an alternative, further embodiments of the water generation systems may include a transfer stage arranged between the first stage and the second stage.

In addition to one or more of the features described herein, or as an alternative, further embodiments of the water generation systems may include that the transfer stage includes an inner housing and an outer housing, wherein the solid waste is deposited into the first stage through an interior of the inner housing and the gaseous hydrogen travels from the first stage to the second stage through an annular passage defined between the inner housing and the outer housing.

In addition to one or more of the features described herein, or as an alternative, further embodiments of the water generation systems may include that a delivery mechanism is arranged within the inner housing and configured to assist depositing the solid waste into the first stage.

In addition to one or more of the features described herein, or as an alternative, further embodiments of the water generation systems may include that the delivery mechanism is a screw feeder that is at least one of manually driven or driven by a motor.

In addition to one or more of the features described herein, or as an alternative, further embodiments of the water generation systems may include a processing catalyst arranged within the processing chamber.

In addition to one or more of the features described herein, or as an alternative, further embodiments of the water generation systems may include that the reacting catalyst comprises at least one of nickel (Ni), platinum (Pt), rhodium (Rh), ruthenium (Ru), and iridium (Ir) on a substrate material of at least one of alumina (Al₂O₃), silica (SiO₂), and zeolite.

In addition to one or more of the features described herein, or as an alternative, further embodiments of the water generation systems may include that the carbon dioxide is sourced from an ambient atmosphere.

In addition to one or more of the features described herein, or as an alternative, further embodiments of the water generation systems may include that the solid waste comprises at least one of waste solid food and plastic food packaging.

In addition to one or more of the features described herein, or as an alternative, further embodiments of the water generation systems may include that the heating element comprises at least one set of plasma torches.

In addition to one or more of the features described herein, or as an alternative, further embodiments of the water generation systems may include that the heating element comprises at least one heating coil operably and thermally connected to a housing of the first stage.

In addition to one or more of the features described herein, or as an alternative, further embodiments of the water generation systems may include a housing, wherein the first stage is defined at one end of the housing and the second stage is defined at an opposite end of the housing.

In addition to one or more of the features described herein, or as an alternative, further embodiments of the water generation systems may include a feed tube that extends from an inlet, through the second stage, and connects to the processing chamber.

In addition to one or more of the features described herein, or as an alternative, further embodiments of the water generation systems may include a transfer stage defined by the housing between the first stage and the second stage, wherein the feed tube passes through the transfer stage and an annular passage is defined between an exterior of the feed tube and an interior surface of the housing that defines the transfer stage.

In addition to one or more of the features described herein, or as an alternative, further embodiments of the water generation systems may include a screw feeder arranged within the feed tube.

In addition to one or more of the features described herein, or as an alternative, further embodiments of the water generation systems may include a one-way feed mechanism arranged at an end of the feed tube and configured to selectively open to deposit solid waste from the feed tube into the processing chamber.

In addition to one or more of the features described herein, or as an alternative, further embodiments of the water generation systems may include a power source operably and electrically connected to the heating element.

The foregoing features and elements may be combined in various combinations without exclusivity, unless expressly indicated otherwise. These features and elements as well as the operation thereof will become more apparent in light of the following description and the accompanying drawings. It should be understood, however, that the following description and drawings are intended to be illustrative and explanatory in nature and non-limiting.

### BRIEF DESCRIPTION OF THE DRAWINGS

The subject matter is particularly pointed out and distinctly claimed at the conclusion of the specification. The foregoing and other features, and advantages of the present disclosure are apparent from the following detailed description taken in conjunction with the accompanying drawings in which:

FIG. 1 is a schematic illustration of a water generation system in accordance with an embodiment of the present disclosure;

FIG. 2 is a schematic illustration of another water generation system in accordance with an embodiment of the present disclosure;

FIG. 3 is a schematic illustration of a first stage of a water generation system in accordance with an embodiment of the present disclosure; and

FIG. 4 is a schematic illustration of a transfer stage and second stage of a water generation system in accordance with an embodiment of the present disclosure.

### DETAILED DESCRIPTION

Space exploration presents a variety of challenges, particularly related to human (viz., manned) space exploration. When humans travel away from Earth, life support must be provided to ensure survivability and safety of the human travelers, whether in a spacecraft or on a celestial object (e.g., moon, planet, asteroid, etc.). One of the primary requirements for human space exploration is a supply of water. Carrying liquid water onboard a spacecraft and/or delivering water to a human occupied station (e.g., on a body, such as Mars) may be difficult to achieve. Further, there may not be a source of local water, such as on the surface of a planet body (e.g., Mars), and thus water must be brought to Mars by spacecraft or must be generated at the location, such as on the surface of Mars. Embodiments of the present disclosure are directed to generating water using local materials (e.g., local atmosphere, surrounding gases, and waste, such as solid waste, etc.), thus carrying a water supply to the destination may not be required. Although described herein with a focus on Mars, it will be appreciated that embodiments of the present disclosure may be applied and used in any situation or environment that has access to the inputs described herein.

The Martian atmosphere is composed mostly of carbon dioxide (CO₂), which accounts for 96 mole % of the total atmosphere. The rest of the Martian atmospheric composition is nitrogen (N₂), argon (Ar), and small amounts of oxygen (O₂). There is no, or very limited, water on the surface of Mars. Finding and extracting any such water may be prohibitive or at least very difficult and may not supply sufficient water for life support and other purposes related to human space exploration. One means to provide water away from Earth may be to carry the water to the planet, which, based on weight and other considerations, maybe prohibitive. Another solution may be to carry cryogenic hydrogen and oxygen tanks from Earth to then be used to supply and produce water by combining the hydrogen with oxygen. However, even with this solution, carrying thousands of kilograms of cryogenic hydrogen and cryogenic oxygen will increase costs related to, at least, launch, transport, and storage. Further, cryogenic hydrogen is subject to boil-off over time, and thus losses will be experienced in this solution. Furthermore, storing and transporting cryogenic gases in tanks (e.g., at temperatures below the boiling point) presents additional challenges, such as the continuous boil-off of stored cryogenic gases when heat enters the storage tanks during storage and transportation.

In view of the above, embodiments of the present are directed to portable water generation systems that may be used to convert local sources of organic materials into water (H₂O). The generated water may be used for life support systems, generation of fuel, and/or for other purposes as will be appreciated by those of skill in the art. The water generation systems described herein may be configured to process organic solid waste (e.g., waste solid food, waste plastics, etc.) to generate hydrogen (H₂) gas. The hydrogen gas may then be reacted with carbon dioxide (CO₂) to produce water (H₂O) and methane gas (CH₄). The water may then be used for consumption, life support, or for other purposes. The methane gas may be vented, stored, or used for other purposes (e.g., generation of fuel).

In accordance with a non-limiting configuration, a water generation system of the present disclosure may be arranged in two sections or configured to operate in two phases. In the first section or phase, a gasifier (also called a dry-reformer or pyrolyzer) is used to thermally decompose solid waste (e.g., waste solid food, waste plastics, etc.) to produce hydrogen gas (H₂). A solid waste feed may be provided to direct the solid waste into a processing chamber or the like. With the solid waste in the processing chamber, heat may be applied to the solid waste, such as by operation or activation of plasma torches or other heat application. The heater may be electrically powered using solar power, batteries (e.g., rechargeable), or other power generation or power storage devices and sources. As the heat is applied, the solid waste will release hydrogen gas and the remainder of the material may be thermally decomposed to carbonaceous residue. The hydrogen gas is reacted with carbon dioxide (CO₂), which may be sourced from local atmosphere. The reacted hydrogen and carbon dioxide will result in the generation of water (H₂O) and methane gas (CH₄). The water may be collected, and the methane gas may be vented or captured for use. In some embodiments, the methane may be thermally decomposed to produce hydrogen and carbon powder. The carbon powder may be collected and used for purification of water (generated by the water generation system or otherwise), for filtering the local atmosphere prior to reacting with the gaseous hydrogen, or for other purposes, as will be appreciated by those of skill in the art.

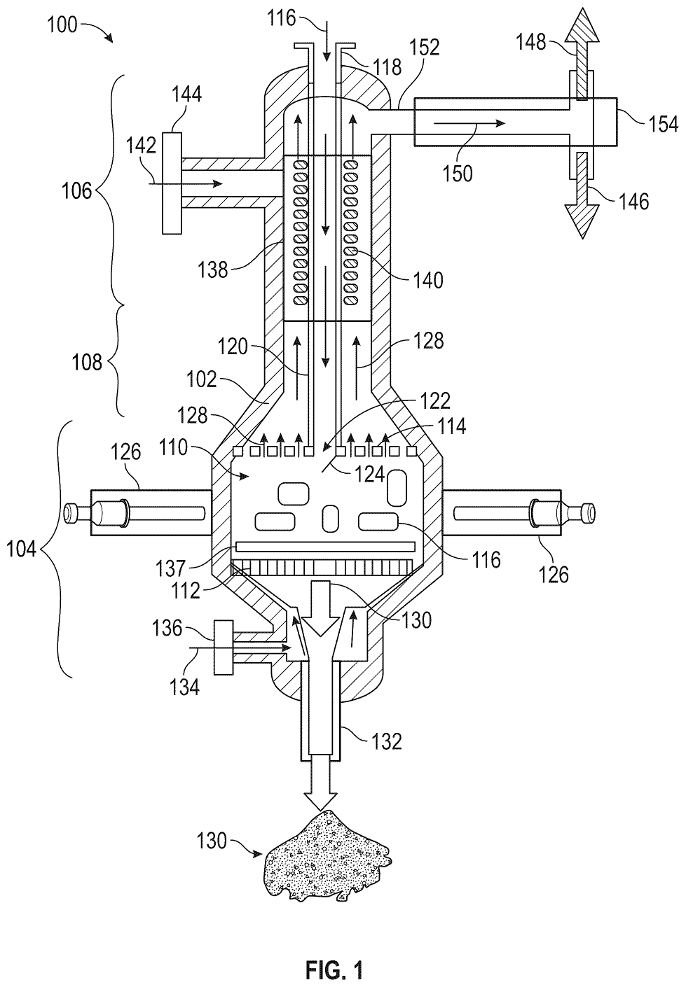

Referring now to FIG. 1, a schematic illustration of a water generation system 100 in accordance with an embodiment of the present disclosure is shown. The water generation system 100 may be used in low gravity environments (e.g., on spacecraft and/or on celestial bodies) and/or may be used on planetary bodies, such as Mars. The water generation system 100 may be substantially portable, able to be carried onboard a spacecraft, as assembled, or the components thereof may be carried to a destination, and then assembled on location. The water generation system 100 is configured to generate water through a two-step process of reducing solid waste down through application of heat to extract or generate gaseous hydrogen and solid carbon (powder form). The gaseous hydrogen may then be reacted or catalyzed with a catalyst and gaseous carbon dioxide to cause the generation of water and methane gas. The water and methane gas may be separated for use, processing, storage, or venting, as appropriate given the specific application and system.

The water generation system 100 includes a housing 102, such as a pressure vessel or the like. The housing 102 may be separated into two stages, sections, or portions, with a first stage 104 configured to perform a thermal decomposition and a second stage 106 configured to react gases to generate water, as described herein. A transfer stage 108 may be arranged between the first stage 104 and the second stage 106, with the transfer stage 108 defining a fluid connection or path from the first stage 104 to the second stage 106. Although the housing 102 is illustrated as a single body structure, in other embodiments, the stages 104, 106, 108 may be distinct structures or housing elements that include a fluid connection therebetween, and in some embodiments the transfer stage 108 may define a fluid connection between the first stage 104 and the second stage 106. The housing 102, in some embodiments and without limitation, may be a stainless-steel structure that is wrapped in a thermal insulating layer, or the like. Such a construction may ensure temperatures and pressures are maintained within the water generation system 100 and to reduce leakages or the like. It will be appreciated that other materials may be used, without departing from the scope of the present disclosure.

The first stage 104 may be arranged and configured as a gasifier (also called a dry-reformer or a pyrolyzer), which is configured to thermally decompose material that deposited therein. The first stage 104 defines a processing chamber 110 that is arranged to receive organic solid waste. As used herein, the term solid waste refers to organic solid waste food (e.g., excess, unconsumed or otherwise non-consumed food) and plastic waste (e.g., plastic wrapping and/or containers used to contain food for the crew members). The processing chamber 110 includes a first perforated plate 112 and a second perforated plate 114. The first perforated plate 112 and the second perforated plate 114 define the processing chamber 110 therebetween.

In this illustrative configuration, the water generation system 100 is arranged vertically to facilitate a downward flow of waste solids and upward flow of generated hydrogen gas. As such, when oriented in this manner, the first perforated plate 112 of the processing chamber 110 is downward or at a bottom of the processing chamber 110 and the second perforated plate 114 is upward or at a top of the processing chamber 110. It will be appreciated that other orientations are possible without departing from the scope of the present disclosure, and the illustrated configuration is provided for explanatory purposes only. Solid waste 116 is deposited into the processing chamber 110 at an inlet 118. The solid waste 116, as noted above, may be solid waste food and/or waste plastic, although other solid waste sources may be employed without departing from the scope of the present disclosure.

The solid waste 116 is deposited into the inlet 118 and passes through a feed tube 120. The feed tube 120 connects the inlet 118 to the processing chamber 110. In this illustrative embodiment the feed tube 120 is arranged internal to the housing 102 and passes through the second stage 106 and the transfer stage 108 of the water generation system 100. The solid waste 116 will enter the processing chamber 110, in this embodiment, through a chamber inlet 122 formed in the second perforated plate 114. The inlet 118, the feed tube 120, and the chamber inlet 122 may be sized to ensure that the solid waste 116 enters the processing chamber 110 without obstruction. The chamber inlet 122 may be provided with a one-way feed mechanism 124 (e.g., a one-valve, biased door or flap, etc.) such that the solid waste 116 may enter the processing chamber 110, but material may be prevented from flowing back up the feed tube 120.

When the solid waste 116 is deposited into the processing chamber 110, the solid waste 116 may be thermally decomposed. For example, in this example embodiment, the water generation system 100 includes one or more heating elements 126 arranged about the processing chamber 110. In this illustrative configuration, the heating elements 126 are arranged as plasma torches that are configured to cause plasma arcs to enter into the processing chamber and interact with the solid waste 116, thus heating the solid waste to thermally decompose the solid waste 116. As the solid waste 116 is heated, the composition of the solid waste 116 will break down and separate into gaseous hydrogen 128 and a carbonaceous byproduct 130 (e.g., leftover carbonaceous solid material, such as carbon powder/ash).

This process may be referred to as gasification, dry reforming reaction, pyrolysis, or thermal decomposition. The gasification thermal energy may be provided by the heating elements 126, which may be powered by electricity. The source of electricity may be determined or based on the available sourced in a given application. For example, and without limitation, in some embodiment the electrical power may be provided by high-efficiency bifacial solar photovoltaic arrays. In such bifacial solar array configurations, solar cells are arranged to populate both sides of a planar solar array, and thus may provide benefits related to surface area, mass, structural reduction, and the like. It will be appreciated that other solar power sources may be employed without departing from the scope of the present disclosure. In some embodiments, in combination with solar, or as a sole or supplemental means of power, batteries may be employed. In a non-limiting example configuration, rechargeable lithium-ion batteries may be used as backup power or a primary source. In some configurations solar arrays may be used to recharge such battery systems. Other electrical sources may be employed, including nuclear, gas turbine generators, other types of reactors, and the like. That is, the heating elements 126 may be provided with electrical power from any appropriate source, and the specific power source is not intended to be limiting to the scope of the present disclosure.

During operation, the carbonaceous byproduct 130 (e.g., solid waste/debris residue, ash, etc.) may fall or otherwise pass through the first perforated plate 112. The first perforated plate 112 contains holes or perforations sized to permit particulate matter, such as carbon ash and other debris, to pass through a byproduct outlet 132 of the water generation system 100. The carbonaceous byproduct 130 may be further processed to be used for other purposes. For example, the carbonaceous byproduct 130 may be formed of or include graphene or graphite which may be used for filtering liquids (e.g., water or other liquids), gases, or the like, or may be used for other purposes, as will be appreciated by those of skill in the art.

The gaseous hydrogen 128 that is released during the thermal treatment in the processing chamber 110 will flow upward, in a direction toward the second stage 106 of the water generation system 100. The gaseous hydrogen 128 may flow through perforations, orifices, openings, or the like formed in the second perforated plate 114. The second perforated plate 114 may include filters or holes sizes selected to ensure that only gaseous fluids flow through the second perforated plate 114. In some embodiments, the second perforated plate 114 may be configured as a set of individual, stacked plates or sheets that are arranged to prevent particulates or the like from being carried in the flow of gaseous hydrogen 128.

In some embodiments, a processing gaseous flow 134 may be provided to assist and ensure that the gaseous hydrogen 128 is directed/carried toward the second section 106 of the water generation system 100. The processing gaseous flow 134 may be directed into and through the processing chamber 110 to pick up, carry, and/or entrain the gaseous hydrogen 128 to flow through the second perforated plate 114. The processing gaseous flow 134 may be a flow of atmospheric gases (e.g., nitrogen, carbon dioxide, etc.) or may be provided from a source such as a tank, supply, or the like. The processing gaseous flow 134 may be driven by a first driving mechanism 136, such as a fan, a pump, or the like. The first driving mechanism 136 may include one or more filters or the like, to ensure that the processing gaseous flow 134 does not contain unwanted components (e.g., entrained particulate matter). In some embodiments the first driving mechanism 136 and any related filters may be separate components that are arranged in series. The processing gaseous flow 134 will provide a motive force for directing the gaseous hydrogen 128 toward the second stage 106 of the water generation system 100. The processing gaseous flow 134 may flow through the first perforated plate 112, into and through the processing chamber 110, and through the second perforated plate 114.

In some configurations, the processing chamber 110 may include an optional processing catalyst 137 or other substance to encourage or promote the release of the gaseous hydrogen 128 from the solid waste 116. In some embodiments, the processing catalyst 137 may be configured with a nickel (Ni)-doped alumina (Al₂O₃) substrate. Other metal catalysts that may be used, for example and without limitation, include platinum (Pt), rhodium (Rh), ruthenium (Ru), and iridium (Ir). Further, other substrate materials that may be used, for example and without limitation, include silica (SiO₂) or zeolite (a crystalline aluminosilicate material).

The gaseous hydrogen 128, alone or mixed with the processing gaseous flow 134, will travel through the transfer stage 108 toward the second stage 106. In this illustrative embodiment, the path of the gaseous hydrogen 128 is inward from the housing 102 and outward from the feed tube 120 which is arranged within the housing 102. As such, the gaseous hydrogen 128 is maintained fluidly separate from the exterior atmosphere outside the housing 102 and fluidly separate from the solid waste 116 and any gases that are within the feed tube 120. The gaseous hydrogen 128 is directed into a reaction chamber 138 that includes a reacting catalyst 140 within the second stage 106 of the water generation system 100. The reacting catalyst 140 of the second stage 106 of the water generation system 100 may be configured to cause a reaction between the gaseous hydrogen 128 and a reactant 142.

The reactant 142 may be a supply or source of carbon dioxide (CO₂) that is intended to react with the gaseous hydrogen 128 at or in the reacting catalyst 140. In some embodiments, the reacting catalyst 140 may be configured with a nickel (Ni)-doped alumina (Al₂O₃) substrate. Other metal catalysts that may be used, for example and without limitation, include platinum (Pt), rhodium (Rh), ruthenium (Ru), and iridium (Ir). Further, other substrate materials that may be used, for example and without limitation, include silica (SiO₂) or zeolite (a crystalline aluminosilicate material).

The source of the reactant 142 (e.g., carbon dioxide) may be a local atmosphere (e.g., Martian atmosphere) or may be provided from some other source, such as crew quarters, a storage system, or the like, as will be appreciated by those of skill in the art. As shown, the reactant 142 may be driven with force into the reaction chamber 138 by a second driving mechanism 144, such as a fan, a pump, or the like. The second driving mechanism 144 may include one or more filters or the like, to ensure that the reactant 142 does not contain unwanted components (e.g., particulates or undesirable gases). In some embodiments the second driving mechanism 144 and any related filters may be separate components that are arranged in series.

In the illustrative example being described, and with continued reference to FIG. 1, as the gaseous hydrogen 128 and the reactant 142 interact within the reaction chamber 138, water 146 and methane 148 will be produced. For example, the catalytic reaction that occurs within the reaction chamber 138 may be described by the following chemical reaction:

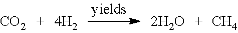

The water 146 may be generated as water vapor and the methane 148 may be in gaseous form. A mixture 150 of the water 146 and the methane 148 will flow through a product outlet 152, which exits from the second stage 106 of the housing 102 of the water generation system 100. The water 146 and the methane 148 may be separated from each other, such that the water 146 is collected and may be used or stored (e.g., for life support systems or other purposes). The methane 148 may be vented out or may be captured and/or processed. In some embodiments, the product outlet 152 may include or may be connected to a separator 154. The separator 154 may be configured to separate the water 146 and the methane 148 into separate flow streams. In some embodiments the separate 154 may be configured as a condenser or the like which condenses water vapor into liquid water, while the methane remains in gaseous form.

As a result, the water generation systems of the present disclosure may be used to convert solid waste materials (e.g., food waste and plastics) into usable water by thermally treating the solid waste materials and reacting released gaseous hydrogen with carbon dioxide to generate water and methane. Advantageously, the source of both the solid waste and the carbon dioxide may be sourced from already carried or present materials/atmosphere. That is, the water generated by the water generation systems described herein can reduce the amount of water required to be carried to a location, such as the surface of Mars. The hydrogen is sourced from food waste that is required for nourishment of the human explorers, and thus is necessarily present on human-based mission, and from the packaging plastic of such food. The carbon dioxide may be sourced from local environments, such as a local atmosphere. In the case of planetary exploration, such as of Mars, the Martian atmosphere may provide the necessary carbon dioxide. In other situations, exhaled carbon dioxide from humans or obtained from other sources, may be used with the water generation systems described herein.

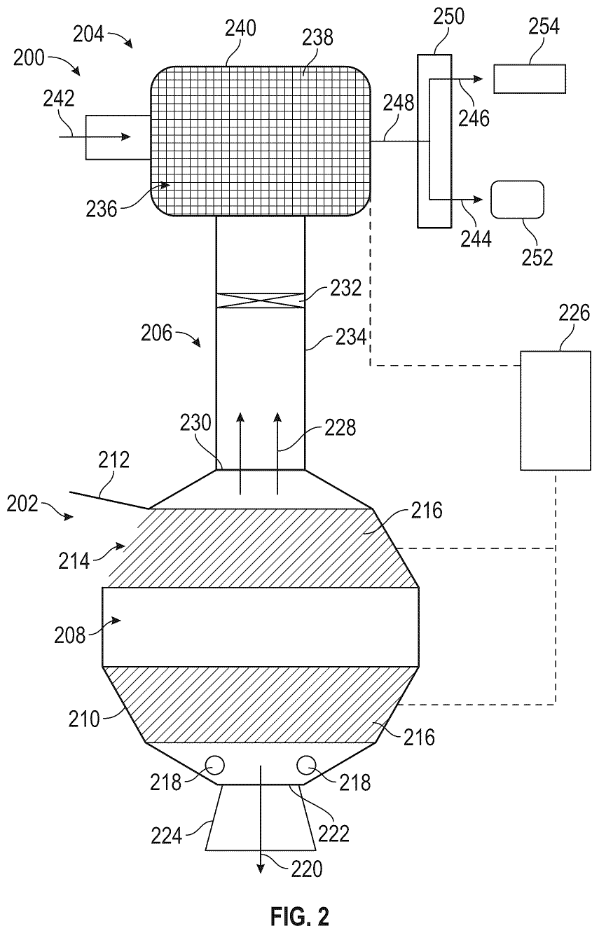

Referring now to FIG. 2, a schematic illustration of a water generation system 200 in accordance with an embodiment of the present disclosure is shown. The water generation system 200 may be similar to the system of FIG. 1, and may be used onboard spacecraft or at space stations or on the surface of non-Earth celestial bodies (e.g., planets, moons, asteroids, etc.). The operation of the water generation system 200 is similar to that of the system of FIG. 1. The water generation system 200 includes a first stage 202 and a second stage 204 connected by a transfer stage 206. The first stage 202 of the water generation system 200 is configured to receive and process solid waste within a processing chamber 208 to generate gaseous hydrogen and the second stage 204 is configured to receive and react the gaseous hydrogen to generate water.

In this illustrative configuration, the water generation system 200 is separated into discrete sections, rather than having a shared housing, as in the water generation system 100 of FIG. 1. As such, in this configuration, the first stage 202 is arranged with a first container or first housing 210 that defines the processing chamber 208 therein. The first stage 202 includes a loading door 212 that is configured to be opened to allow insertion or depositing of solid waste (e.g., solid waste food and/or plastic material) into the processing chamber 208 through a loading inlet 214. The loading door 212 may be closed and sealed to fluidly seal, separate, or close the processing chamber 208 from an ambient environment. An optional transfer stage 206 may be attached to the first stage 202, such as by threaded connection, fasteners, welding, bonding, adhesives, or other means of connection and attachment. Attached at an opposite end of the transfer stage 206 from the first stage 202 is the second stage 204. The second stage 204 may connect to the transfer stage 206 (if present) or directly to the first stage 202 (if no transfer stage present) by known mechanisms, such as threaded connections, fasteners, welding, bonding, adhesives, or other means of connection and attachment. It will be appreciated that the connections between the various stages 202, 204, 206 may include seals, gaskets, sealing elements, and/or features to reduce or minimize losses from the interior of the water generation system 200.

The first stage 202 is configured within one or more heating elements 216. The heating elements 216 in this embodiment are wrapped about an exterior surface of the first housing 210 and are configured to apply heat to the first housing 210 and thus induce thermal decomposition of solid waste that is deposited into the processing chamber 208. Although described with the heating elements 216 arranged on an outer surface of the first housing 210, in other embodiments, the heating elements may be arranged on an interior surface of the housing, embedded or otherwise incorporated into the walls of the housing, or the like. Further, other types of heating elements and heating mechanisms may be employed without departing from the scope of the present disclosure. Similar to the embodiment of FIG. 1, the water generation system 200 can include one or more processing flow inlets 218 which may be arranged to direct a processing gaseous flow of air (e.g., ambient air) into and through the processing chamber 208. After a processing operation, a carbonaceous byproduct 220 (e.g., leftover solid material, such as ash) may pass through a first perforated plate 222 which contains holes or perforations size to permit particulate matter, such as ash and other debris (the carbonaceous byproduct 220), to pass through a byproduct outlet 224 of the water generation system 200.

During the processing operation, electrical power may be provided to the heating elements 216. As shown in FIG. 2, a power source 226 may be electrically connected to the heating elements 216. The power source 226 may include electrical power generation elements and components (e.g., solar panels, generators, turbines, etc.) and control elements associated therewith. Further, in some embodiments, the power source 226 may be arranged as a set of batteries (e.g., rechargeable) and/or may include batteries that can be charged and used when a power generator (e.g., solar panels) is not actively generating electricity and/or when a power generator fails. In some configurations, the heating elements 216 may include a combination of heating wrap elements and plasma torches or other direct thermal energy application systems.

As the heat is applied to the solid waste in the processing chamber 208, gaseous hydrogen 228 will be released and flow toward the second stage 204 of the water generation system 200 through a second perforated plate 230. The gaseous hydrogen 228 may be driven, in part, by the processing gaseous flow received through or from the processing flow inlets 218. In this illustrative embodiment that includes the transfer stage 206, the gaseous hydrogen 228 may be pulled from the processing chamber 208 by operation of a driving mechanism 232 which may be arranged within a transfer tube 234 between the first stage 202 and the second stage 204 of the water generation system 200.

The gaseous hydrogen 228 is passed into the second stage 204 and enter a reaction chamber 236 that includes a reacting catalyst 238. The reacting catalyst 238 is housed within a second housing 240. The gaseous hydrogen 228 is reacted with a reactant 242, which may be a supply or source of carbon dioxide that is intended to react with the gaseous hydrogen 228 at or in the reacting catalyst 238. In some embodiments, electrical power may be provided from the power source 226 to the reacting catalyst 238 to support the catalytic reaction therein, as will be provided by those of skill in the art.

As described above, the reaction within the reaction chamber 236 results in the generation of water 244 and methane 246 by catalyzing the gaseous hydrogen 228 with the reactant 242 (e.g., carbon dioxide). A mixture 248 of water and methane is directed into a separator 250 for separation of the water 244 and methane 246. The water 244 may be collected in a water storage device 252 which may be part of a life support system and the methane 246 may be vented or captured in a methane capture device 254, and used for other purposes.

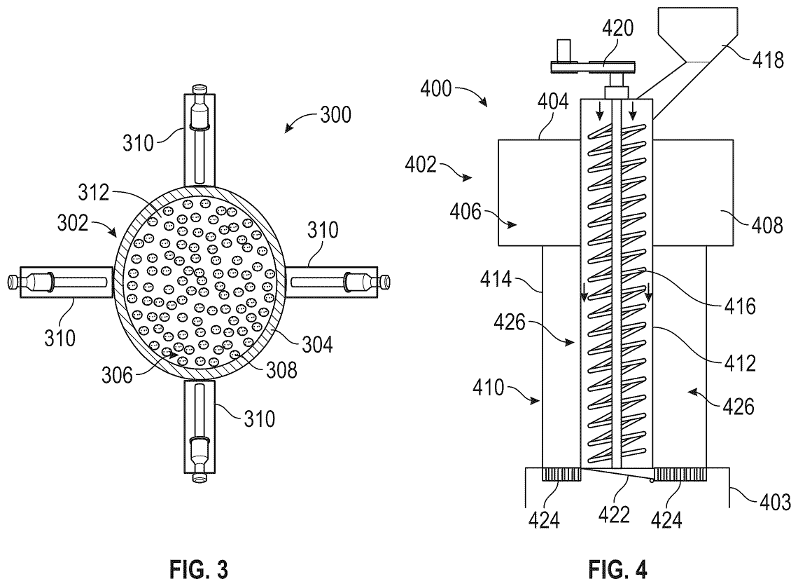

Referring now to FIG. 3, a schematic illustration of a first stage or portion of a water generation system 300 in accordance with an embodiment of the present disclosure is shown. FIG. 3 illustrates a first stage 302 of the water generation system 300, which includes a first housing 304 that defines a processing chamber 306 therein. Solid waste 308, such as waste solid food and/or plastic (e.g., used for containing the food) may be deposited into the processing chamber 306, as described above. The water generation system 300 is configured with multiple plasma torches 310. The plasma torches 310 are arranged as pairs such at electrical arcs may extend between two of the plasma torches 310. The solid waste 308 that is between the plasma torches 310 will be heated through sparking from electrodes of the plasma torches 310, which induce high voltage sparks. In accordance with some non-limiting embodiments, the plasma torches 310, or other heating elements used with systems described herein, may be configured to cause temperatures within the processing chamber 306 to reach 350° C. to 600° C. or greater. In accordance with some embodiments, the plasma torches 310 may have a power level of 5 kW, although other power levels may be employed without departing from the scope of the present disclosure.

The gasification operation performed within the processing chamber 306 may be induced, in part, by inclusion of a catalyst 312 within the processing chamber 306, as discussed above. As noted above, various heating elements may be employed, such as and without limitation, plasma torches, heating coils, electrodes, or the like. The solid waste 308 is formed of hydrocarbon molecule, which in the presence of an inert carrier gas (e.g., processing gaseous flow) will be induced to break down into hydrogen gas (H₂), carbon monoxide (CO), carbon dioxide (CO₂), and non-volatile compounds (e.g., carbonaceous byproduct). The carbon monoxide (CO) and the carbon dioxide (CO₂) may be used as carrier gases and serve as a portion of the reactants that react with the gaseous hydrogen (H₂) in the second stage, as described above. The carbon monoxide (CO) may react with the hydrogen gas (H₂) in the second stage within the reaction chamber to produce water (H₂O) and methane (CH₄) as described by the following reaction:

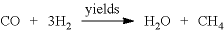

Referring now to FIG. 4, a schematic illustration of a second stage or portion of a water generation system 400 in accordance with an embodiment of the present disclosure is shown. FIG. 4 illustrates a second stage 402 of the water generation system 400, which includes a second housing 404 that defines a reaction chamber 406 that includes a reacting catalyst 408 therein. Also shown in FIG. 4 is a transfer stage 410 which is configured to enable deposition of solid waste into a first stage 403 and to direct gaseous hydrogen from the first stage 403 to the second stage 402. As shown, the second stage 402 is arranged at one end of the transfer stage 410, and the first stage 403 is arranged at the opposite end of the transfer stage 410.

The transfer stage 410, in this illustrative embodiment, includes an inner housing 412 and an outer housing 414. Within the inner housing 412 is a delivery mechanism 416, such as a screw feeder. The delivery mechanism 416 is configured to receive solid waste (e.g., solid waste food and/or plastic waste) from a hopper 418 or other input structure or opening. The delivery mechanism 416 may then operate to carry or direct the solid waste to the first stage 403. The delivery mechanism 416 arranged within the inner housing 412 may be driven by a driver 420, such as an electric motor, manual crank, or the like. The solid waste will exit the inner housing 412 through a one-way feed mechanism 422 (e.g., one-way valve, door, or the like), that permits the solid waste to enter the first stage 403 but prevents back flow up through the inner housing 412. When the solid waste is processed in a processing chamber of the first stage 403, gaseous hydrogen is released and may flow through or be carried through (e.g., on a carrier or processing gaseous flow) a perforated plate 424. The gaseous hydrogen will then flow through an annular passage 426 defined between the inner housing 412 and the outer housing 414 of the transfer stage 410. The gaseous hydrogen may then enter the reaction chamber 406 and reacting catalyst 408 of the second stage 402, where water and methane may be produced, as described above.

The above described and illustrated embodiments are merely for illustrative and explanatory purposes. It will be appreciated that features and aspects of the various embodiments may be combined or arranged in configurations not specifically illustrated or described, without departing from the scope of the present disclosure. For example, as noted above, in some embodiments, a transfer stage may be omitted with substantially direct connection between the first stage (for gasification) and the second stage (for water and methane generation).

Advantageously, embodiments described herein provide for improved water generation systems, particularly at non-Earth locations, such as on Mars or other celestial bodies or in space (e.g., on a spacecraft). The water generation systems described herein are configured to convert solid waste, including solid food waste and plastics used for packaging of foods. These solid materials include various hydrocarbons and other non-volatile compounds. By applying heat, a dry reforming reaction, pyrolysis, or thermal decomposition may be achieved, resulting in the release of gaseous hydrogen and generation of a carbonaceous byproduct of the non-volatile compounds. The gaseous hydrogen may then be reacted with carbon dioxide to generate water and methane. Advantageously, the carbon dioxide may be locally sourced (e.g., local atmosphere) and the hydrogen may be sourced from materials that are already intended to be present on space missions (e.g., food and food packaging).

The water generated by the water generation systems described herein may be used for various life support systems, such as for drinking water, cooling, or the like. In some embodiments, the water generation systems may be self-sufficient, in the sense that electrical power may be provided by solar panels and/or batteries that are electrically connected to or part of the water generation system. In other embodiments, local power sources may be used to power the water generation systems and/or may be used to supplement dedicated power sources of the water generations systems.

Advantageously, embodiments of the present disclosure reduce the requirements for supplying water to human-based (i.e., crewed) space exploration mission by enabling on-site or on-location water generation from waste that is generated by the human travelers. For example, there is no liquid water on Mars and transporting several thousands of kilograms of cryogenic hydrogen from Earth to Mars, for the required distances and times, is extremely challenging. Further, bringing water directly is even more difficult. Rather than bringing these materials and components for water production at locations remote from Earth, embodiments of the present disclosure allow for direct generation of liquid water by using waste and local atmosphere (rich in carbon dioxide).

The use of the terms “a”, “an”, “the”, and similar references in the context of description (especially in the context of the following claims) are to be construed to cover both the singular and the plural, unless otherwise indicated herein or specifically contradicted by context. The modifier “about” used in connection with a quantity is inclusive of the stated value and has the meaning dictated by the context (e.g., it includes the degree of error associated with measurement of the particular quantity). All ranges disclosed herein are inclusive of the endpoints, and the endpoints are independently combinable with each other.

While the present disclosure has been described in detail in connection with only a limited number of embodiments, it should be readily understood that the present disclosure is not limited to such disclosed embodiments. Rather, the present disclosure can be modified to incorporate any number of variations, alterations, substitutions, combinations, sub-combinations, or equivalent arrangements not heretofore described, but which are commensurate with the scope of the present disclosure. Additionally, while various embodiments of the present disclosure have been described, it is to be understood that aspects of the present disclosure may include only some of the described embodiments. Accordingly, the present disclosure is not to be seen as limited by the foregoing description, but is only limited by the scope of the appended claims.

What is claimed is:

1. A water generation system comprising:
a first stage defining a processing chamber;
a heating element operably coupled to the first stage and configured to cause a temperature of the processing chamber to reach at least 350° C. to perform a gasification operation on solid waste deposited within the processing chamber to release gaseous hydrogen; and
a second stage defining a reaction chamber that includes a reacting catalyst arranged within the reaction chamber, the reacting catalyst configured to catalyze gaseous hydrogen released from the solid waste and carbon dioxide to generate water and methane.

2. The water generation system of claim 1, wherein the processing chamber is defined between a first perforated plate and a second perforated plate, wherein the second perforated plate is arranged between the processing chamber and the reaction chamber in a flow direction of the gaseous hydrogen.

3. The water generation system of claim 2, wherein the second perforated plate comprises at least one of filters and holes sizes selected to permit gaseous hydrogen to pass therethrough and prevent particulate matter from passing therethrough.

4. The water generation system of claim 2, wherein the first perforated plate comprises holes or opening sized to permit a carbonaceous byproduct to pass therethrough and exit the processing chamber.

5. The water generation system of claim 1, further comprising a transfer stage arranged between the first stage and the second stage.

6. The water generation system of claim 5, wherein the transfer stage comprises:
an inner housing; and
an outer housing, wherein the solid waste is deposited into the first stage through an interior of the inner housing and the gaseous hydrogen travels from the first stage to the second stage through an annular passage defined between the inner housing and the outer housing.

7. The water generation system of claim 6, wherein a delivery mechanism is arranged within the inner housing and configured to assist depositing the solid waste into the first stage.

8. The water generation system of claim 7, wherein the delivery mechanism is a screw feeder that is at least one of manually driven or driven by a motor.

9. The water generation system of claim 1, further comprising a processing catalyst arranged within the processing chamber.

10. The water generation system of claim 1, wherein the reacting catalyst comprises at least one of nickel (Ni), platinum (Pt), rhodium (Rh), ruthenium (Ru), and iridium (Ir) on a substrate material of at least one of alumina (Al₂O₃), silica (SiO₂), and zeolite.

11. The water generation system of claim 1, wherein the carbon dioxide is sourced from an ambient atmosphere.

12. The water generation system of claim 1, wherein the solid waste comprises at least one of waste solid food and plastic food packaging.

13. The water generation system of claim 1, wherein the heating element comprises at least one set of plasma torches.

14. The water generation system of claim 1, wherein the heating element comprises at least one heating coil operably and thermally connected to a housing of the first stage.

15. The water generation system of claim 1, further comprising a housing, wherein the first stage is defined at one end of the housing and the second stage is defined at an opposite end of the housing.

16. The water generation system of claim 15, further comprising a feed tube that extends from an inlet, through the second stage, and connects to the processing chamber.

17. The water generation system of claim 16, further comprising a transfer stage defined by the housing between the first stage and the second stage, wherein the feed tube passes through the transfer stage and an annular passage is defined between an exterior of the feed tube and an interior surface of the housing that defines the transfer stage.

18. The water generation system of claim 17, further comprising a screw feeder arranged within the feed tube.

19. The water generation system of claim 17, further comprising a one-way feed mechanism arranged at an end of the feed tube and configured to selectively open to deposit solid waste from the feed tube into the processing chamber.

20. The water generation system of claim 1, further comprising a power source operably and electrically connected to the heating element.
